(19) United States
(12) Patent Application Publication
(10) Pub. No.: US 2025/0178180 A1
(43) Pub. Date: Jun. 5, 2025

(54) DRILLING POSITIONING DEVICE

(71) Applicant: Da Gu Hardware CO., LTD., Changhua County (TW)

(72) Inventor: CHIA-HAO YANG, Changhua County (TW)

(21) Appl. No.: 18/525,906

(22) Filed: Dec. 1, 2023

(51) Int. Cl. B25H 1/00

(52) U.S. Cl. CPC B25H 1/0078

(57) ABSTRACT

A drilling positioning device includes a main body, a handgrip part, and a center line. The main body has a first side and a second side disposed in a parallel arrangement along a first direction, and a first bores row and a second bores row disposed in a parallel arrangement at intervals along a second direction perpendicular to the first direction. The handgrip part is pivotally disposed on the first side and includes an observation hole. The center line extends along the second direction from the handgrip part toward the second side between the first bores row and the second bores row and is arranged in parallel thereto. The center line is aligned with a mark line on a drawer, so that drilling marks are drawn through the first and second bores rows, allowing the fastening bores to be drilled at predetermined positions.

### BACKGROUND OF THE INVENTION

### 1. Field of the Invention

The present invention relates to positioning devices, and more particularly, to a drilling positioning device.

### 2. Description of the Related Art

In the assembly process of a traditional DIY drawer, a plastic drilling positioning plate is usually used. The drilling positioning plate often includes preset bore positions to guide the electric drill during the drilling operation, so that holes are accordingly formed for a handle to be fastened to the drawer through the fasteners.

However, the drilling positioning plate is usually made of plastic, and plastic products usually cause adverse effects on the environment, including the waste of resource and waste disposal issues during the production process, failing to meet the needs for environmentally friendly products and technologies. Also, the hole positions of the drilling positioning plate are usually preset and cannot be adjusted or customized according to specific demands, so that the flexibility and adaptability when assembling the drawer are limited, failing to meet the needs of sizes and configurations alterations.

### SUMMARY OF THE INVENTION

To improve the issues above, the present invention discloses a drilling positioning device, whose center line is aligned with the mark line on the drawer for facilitating an accurate drilling mark, through which the fastening bores are drilled at predetermined positions, achieving a simple operation and an efficiently positioning effects.

For achieving the aforementioned objectives, a drilling positioning device in accordance with an embodiment of the present invention comprises a main body, a handgrip part, and a center line. The main body comprises a first side and a second side disposed in a parallel arrangement along a first direction, and a first bores row and a second bores row disposed in a parallel arrangement at intervals along a second direction perpendicular to the first direction. The handgrip part is pivotally disposed on the first side and comprises an observation hole. The center line extends along the second direction from the handgrip part toward the second side between the first bores row and the second bores row and is arranged in parallel to the first bores row and the second bores row.

With such configuration, the center line of the present invention is aligned to the mark line on the drawer, allowing drilling marks to be drawn by use of the first bores row and the second bores row, allowing the fastening bores to be drilled at predetermined positions.

In another embodiment of the present invention, the main body comprises a size scale disposed along the second direction in adjacent to the second bores row. Also, the main body is formed of paper. Therefore, additional apertures are directly formed on the main body by use of the drill according to the marks of the size scale, forming the fastening bores needed on the target object for the to-be-installed object to be installed on the target object, thereby facilitating the flexibility and convenience of assembly.

### BRIEF DESCRIPTION OF THE DRAWINGS

FIG. 1 is a front view of the drilling positioning device in accordance with an embodiment of the present invention.

FIG. 2 is a schematic view of the operation status of the drilling positioning device in accordance with an embodiment of the present invention, illustrating the handgrip part resting upon the top face of the drawer, with the center line in aligned with the mark line.

FIG. 3 is a schematic view illustrating the drill drilling two drilling marks.

FIG. 4 is a schematic view illustrating the handle being fastened to the drawer by use of screws.

FIG. 5 is a schematic view of another operation embodiment of the present invention, illustrating the mark line drawn on the top face of the drawer.

FIG. 6 is a schematic view continuing FIG. 5, illustrating the first indication line in alignment with the mark line.

FIG. 7 is another front view of the drilling positioning device, illustrating additional apertures being drilled on the main body.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features.

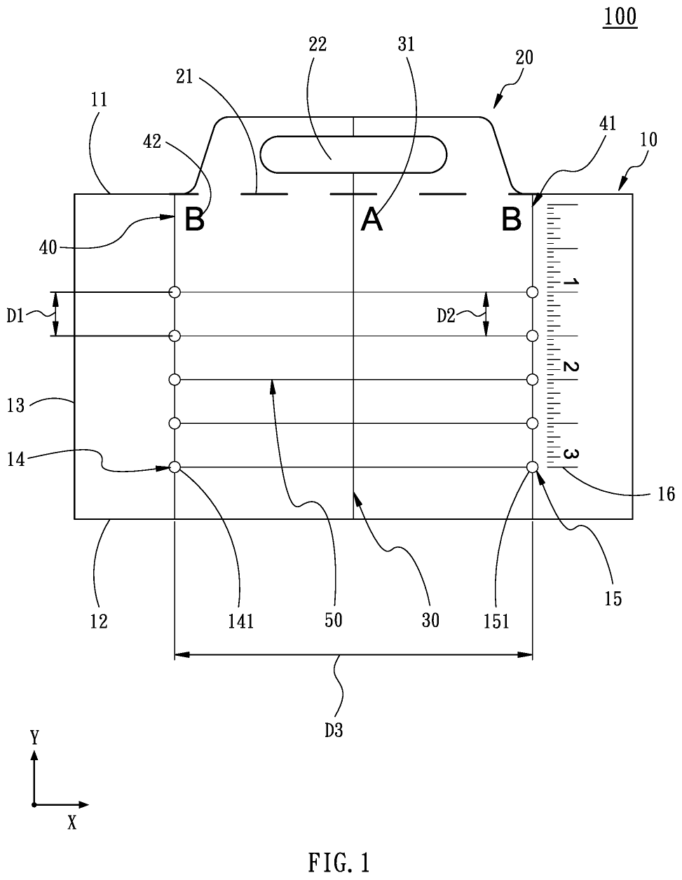

Referring to FIG. 1 to FIG. 5, the present invention discloses a drilling positioning device 100, comprising a main body 10 and a handgrip part 20. The present invention is applied for facilitating the positioning process of bore drilling operation during the installation of a handle 1 on a drawer 200, whereby the bores are accurately drilled for the handle 1 to be accurately fastened to the drawer 200.

The main body 10 is made of paper. The main body 10 comprises a first side 11 and a second side 12 disposed along a first direction X in a parallel arrangement. Two third sides 13 are connected between the first side 11 and the second side 12, wherein the length of the first side 11 is larger than the length of each third side 13. In the embodiment, the main body 10 comprises a first bores row 14 and a second bores row 15 disposed along a second direction Y perpendicular to the first direction X; the first bores row 14 and the second bores row 15 are arranged at parallel intervals to each other.

The first bores row 14 comprises a plurality of first bores 141 disposed along the second direction Y at a first interval D1. The second bores row 15 comprises a plurality of second bores 151 disposed along the second direction Y at a second interval D2. The first interval D1 is identical to the second interval D2. A third interval D3 is arranged between the first bores 141 and the positionally corresponding second bores 151, wherein the third interval D3 is three times to six times the first interval D1. In the embodiment, the present invention comprises, five first bores 141 and five second bores 151.

In the embodiment, the present invention further comprises a size scale 16 disposed along the second direction Y. The size scale 16 is printed on the main body 10 in adjacent to the second bores row 15. The size scale 16 is presented based on the metric system.

The handgrip part 20 is pivotally disposed on the first side 11 of the main body 10. A folding line 21 is formed between the first side 11 and the handgrip part 20. The handgrip part 20 pivots about the folding line 21 with respect to the main body 10. The handgrip part 20 comprises an observation hole 22 for the user to hold or to be used for aligning the lines.

In the embodiment, the present invention further comprises a center line 30 extending along the second direction Y from the handgrip part 20 toward the second side 12. Therein, the center line 30 is printed on the same side of the handgrip part 20 and the main body 10, and arranged in the middle of the two third sides 13, and also arranged between and in parallel to the first bores row 14 and the second bores row 15. The center line 30 comprises a first mark 31 disposed on one side of the intersection of the center line 30 and the folding line 21. The first mark 31 serves as an auxiliary guide for the user to draw a central line in the observation hole 22 with a pencil or pen. Also, the center line 30 is presented on two sides of the observation hole 22, so that when the handgrip part 20 pivots to be bent with respect to the main body 10, the user is still allowed to observe the position of the center line 30 from two sides of the observation hole 22, so as to draw a line in alignment with the center line 30 through the observation hole 22.

In the embodiment, the present invention further comprises a first indication line 40 and a second indication line 41 in parallel to the first indication line 40. The first indication line 40 passes through the first bores row 14 from the first side 11 and extends to the second side 12. The second indication line 41 passes through the second bores row 15 from the first side 11 and extends to the second side 12. Both the first indication line 40 and the second indication line 41 comprise a second mark 42 on one side of the first side 11, respectively. The second mark 42 serves as an auxiliary guide for the user to draw position bores through each first bore 141 and each second bore 151 with a pencil or pen. Therein, the third interval D3 is larger than a length of the handgrip part 20 on the first direction X, so that when the handgrip part 20 pivots with respect to the main body 10, the first indication line 40 and the second indication line 41 serve as a guide mark.

In the embodiment, the present invention further comprises a transverse indication line 50 disposed in parallel to the first direction X. The transverse indication line 50 passes through the center line 30 to be connected between the first bores row 14 and the second bores row 15, serving as a drilling guide for the user.

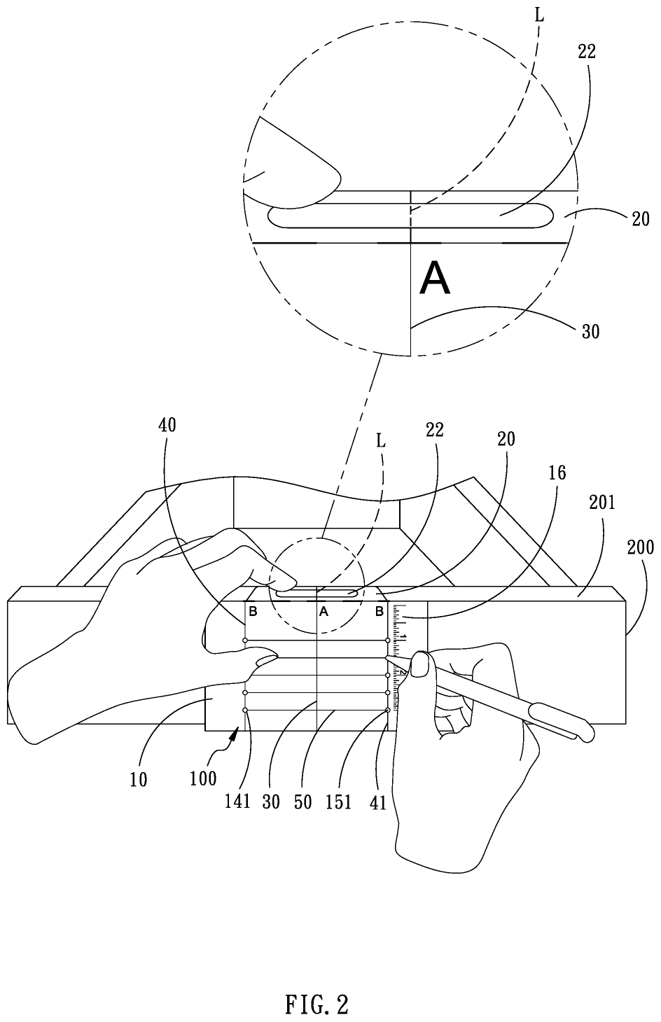

Referring to FIG. 2 to FIG. 4, the drilling operation is carried out by use of the drilling positioning device 100 of the present invention. First, as shown by FIG. 2, a top face 201 of the drawer 200 comprises a preset mark line L, which is the central line of the drawer 200.

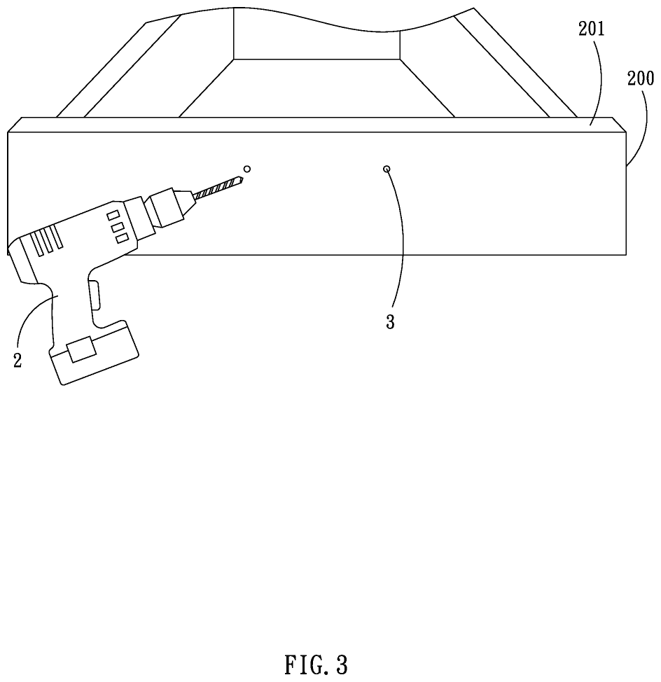

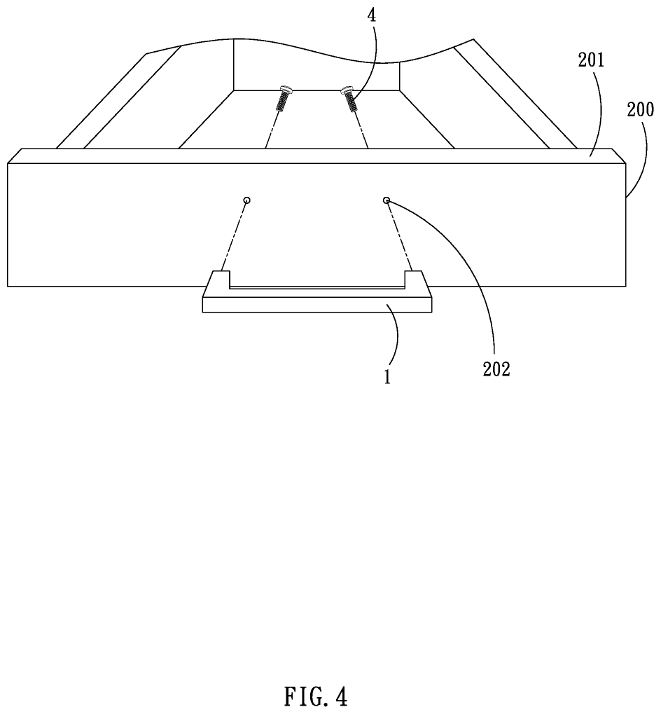

Next, the handgrip part 20 pivots with respect to the main body 10, so that the handgrip part 20 rests upon the top face 201 of the drawer 200. The user observes the position of the center line 30 through two sides of the observation hole 22, so as to align the center line 30 with the mark line L. Then, based on the to-be-drilled positions, the user uses a pencil or pen to draw two drilling marks 3 through the first bore 141 and the corresponding second bore 151, wherein the distances between the two drilling marks 3 and the central line of the drawer 200 are equal. Referring to FIG. 3 and FIG. 4, the user then uses a drill 2 to drill the two drilling marks 3 in a perfectly straight orientation, so as to drill the needed through holes 202 on the drawer 200. When two through holes 202 are drilled in the drawer 200 after the previous process, the handle 1 is fastened and fixed to the drawer 200 by use of screws 4, finishing the installation operation of the handle 1.

With the foregoing configuration, the center line 30 of the present invention is aligned with the central line of the drawer 200, allowing the handle 1 to be accurately installed at the middle position of the drawer 200, achieving the operation simplicity and convenience. Also, the drilling positioning device 100 is made of paper, achieving the environmentally friendly advantage.

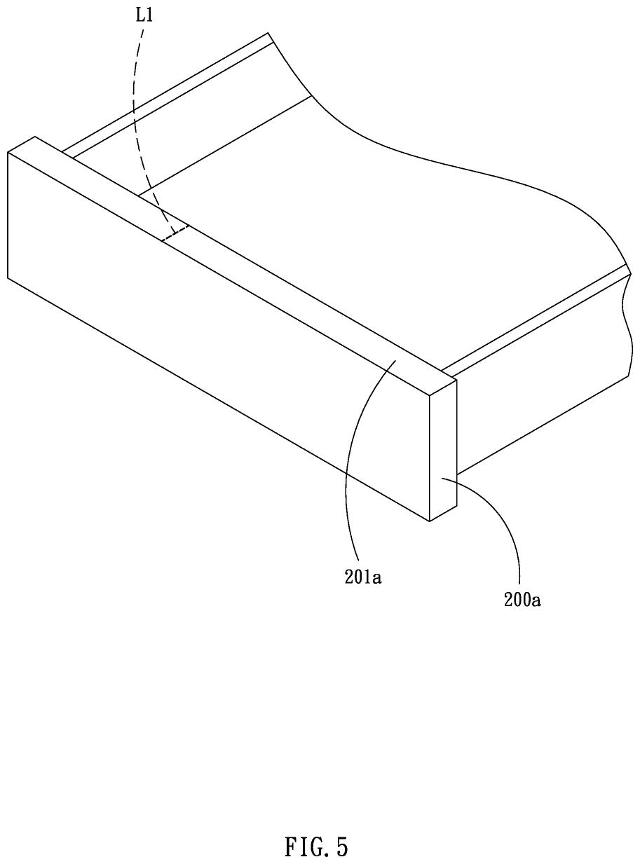

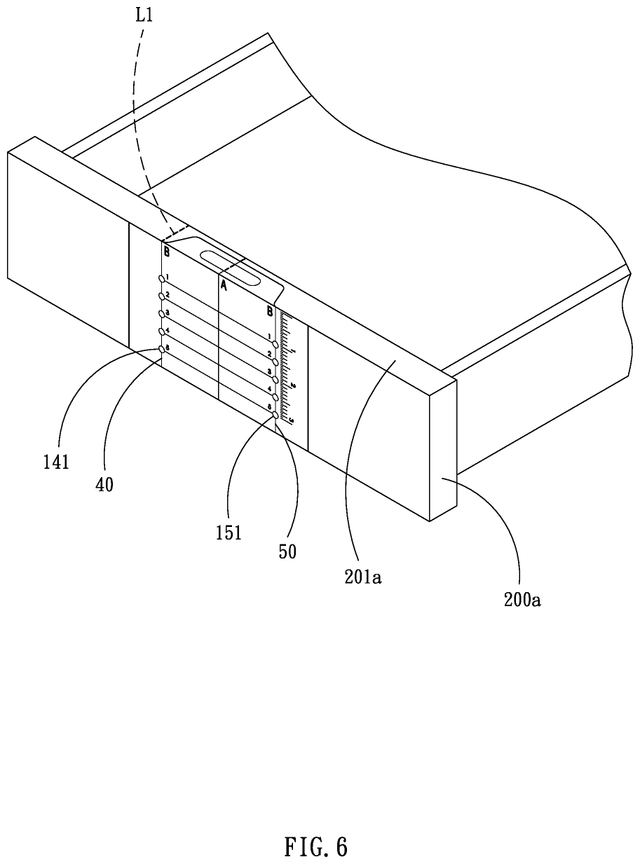

Referring to FIG. 5 and FIG. 6, another operation embodiment of the drilling positioning device 100 is illustrated. As shown by FIG. 5, a mark line L1 is drawn on a top face 201a of a drawer 200a, wherein the mark line L1 is 2.5 or 3 inches away from the edge of the drawer 200a.

Then, as shown by FIG. 6, the handgrip part 20 is pivoted with respect to the main body 10, such that the handgrip part 20 rests upon the top face 201a of the drawer 200a, and the first indication line 40 is aligned with the mark line L1. Next, according to the drilling positions needed, the two drilling marks 3 are drawn through the first bore 141 and the second bore 151, as shown by FIG. 3.

Afterward, referring to the aforementioned steps shown by FIG. 3 and FIG. 4, the bore drilling operation is continued, so as to finish the handle 1 installation.

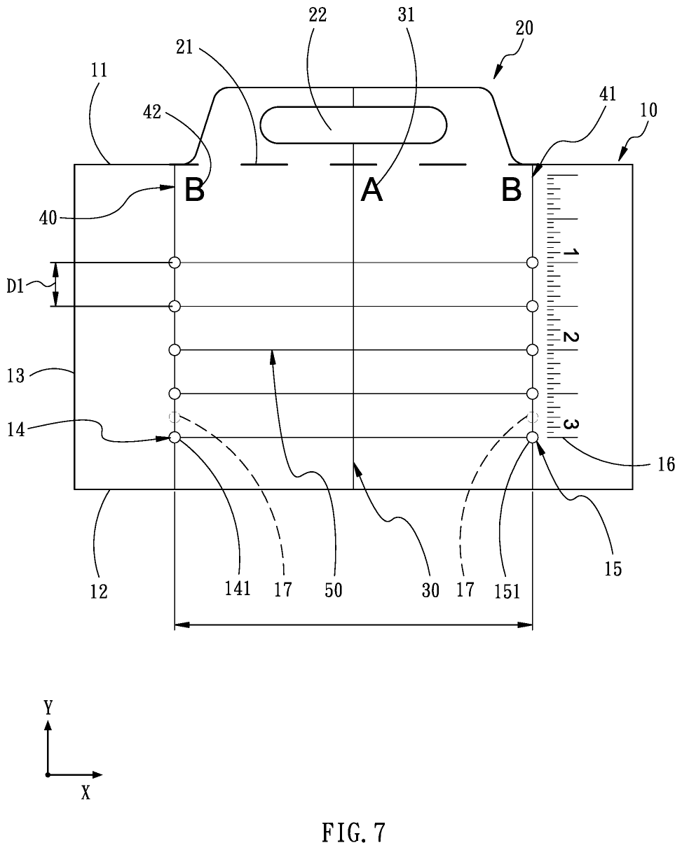

Referring to FIG. 7, based on the fact that the main body 10 is made of paper and comprises the size scale 16, the user is allowed to, according to marks of the size scale 16, use the drill 2 shown by FIG. 3 to drill additional apertures 17 on the main body 10, so as to drill the needed fastening bores on a target object, whereby a to-be-installed object is installed on the target object, achieving the flexibility and convenience of assembly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A drilling positioning device, comprising:
a main body comprising a first side and a second side disposed in a parallel arrangement along a first direction, and a first bores row and a second bores row disposed in a parallel arrangement at intervals along a second direction perpendicular to the first direction;
a handgrip part pivotally disposed on the first side and comprising an observation hole; and
a center line extending along the second direction from the handgrip part toward the second side between the first bores row and the second bores row, and arranged in parallel to the first bores row and the second bores row.

2. The drilling positioning device of claim 1, further comprising a size scale disposed along the second direction and arranged in adjacent to the second bores row.

3. The drilling positioning device of claim 2, wherein the size scale is presented based on metric system.

4. The drilling positioning device of claim 1, wherein a folding line is disposed between the first side and the handgrip part, so that the handgrip part pivots about the folding line with respect to the main body; the center line is presented on two sides of the observation hole.

5. The drilling positioning device of claim 4, wherein the center line comprises a first mark disposed on one side of an intersection of the center line and the folding line.

6. The drilling positioning device of claim 5, further comprising a first indication line and a second indication line in parallel to the first indication line, the first indication line passing through the first bores row from the first side to the second side, the second indication line passing through the second bores row from the first side to the second side.

7. The drilling positioning device of claim 6, wherein the first indication line and the second indication line comprise a second mark on one side of the first side, respectively.

8. The drilling positioning device of claim 7, further comprising a transverse indication line disposed in parallel to the first direction, the transverse indication line passing through the center line to be connected between the first bores row and the second bores row.

9. The drilling positioning device of claim 8, wherein two third sides are connected between the first side and the second side, wherein a length of the first side is larger than a length of the third sides.

10. The drilling positioning device of claim 9, wherein the first bores row comprises a plurality of first bores disposed along the second direction at a first interval; the second bores row comprises a plurality of second bores disposed along the second direction at a second interval; the first interval is identical to the second interval.

11. The drilling positioning device of claim 10, wherein a third interval is arranged between the first bores and the positionally corresponding second bores; the third interval is larger than a length of the handgrip part on the first direction.

12. The drilling positioning device of claim 11, wherein the third interval is three times to six times the first interval.

13. The drilling positioning device of claim 12, further comprising a size scale disposed along the second direction and arranged in adjacent to the second bores row.

14. The drilling positioning device of claim 13, wherein the size scale is presented based on metric system.

15. The drilling positioning device of claim 14, wherein the main body is made of paper.
